(19) United States
(12) Patent Application Publication
(10) Pub. No.: US 2014/0063246 A1
(43) Pub. Date: Mar. 6, 2014

(54) VEHICLE BACK-UP CAMERA CAPABILITY

(71) Applicant: Michael J. Kearney, Farmington Hills, MI (US)

(72) Inventor: Michael J. Kearney, Farmington Hills, MI (US)

(73) Assignee: GM GLOBAL TECHNOLOGY OPERATIONS LLC, Detroit, MI (US)

(21) Appl. No.: 13/600,720

(22) Filed: Aug. 31, 2012

(51) Int. Cl. H04N 7/18

(52) U.S. Cl. 348/148; 348/E07.085

(57) ABSTRACT

Implementing vehicle back-up camera capabilities includes receiving, at a computer processor, dimensions of a vehicle extension for a vehicle make and model. The vehicle back-up camera capabilities also include integrating, via the computer processor, the dimensions with image software of a recording system on a vehicle having the vehicle make and model. The vehicle back-up cameral capabilities also include translating the dimensions to scale with a scaling component of the recording system, and overlaying a graphical depiction of the vehicle extension with a recorded image on a display device using translated dimensions.

### FIELD OF THE INVENTION

The subject invention relates to vehicle information and controls and, more particularly, to vehicle back-up camera capabilities.

### BACKGROUND

Back-up camera systems in automobiles provide drivers with a rear view of a back-up operation when a vehicle is put in reverse gear in order for drivers to view and avoid any potential obstacles, as well as safely guide the drivers through a pathway, such as a drive-way, parking lot, etc.

Many of these vehicles are equipped with vehicle extensions that add additional length to the vehicles based on the open or activated positions of these extensions. For example, pick-up trucks typically include a rear tail gate that can be opened and closed for loading and unloading items into a truck bed. Also, many types of vans are equipped with rear lift gates also for assisting operators in loading and unloading items in the interior compartment of the vans. These types of vehicles can be very useful when individuals need to transport bulky or heavy items. In most instances, the vehicle operator can back up to a pick up point, such that the distance in which manual movement of the items is minimized. When using a back-up camera system, however, it is difficult for the operator to visually determine how far to back up the vehicle when approaching a loading point, particularly when the tail gate is closed or the lift gate is deactivated.

Accordingly, it is desirable to provide back-up camera capabilities to vehicles that include a visual representation of the dimensions of a vehicle extension.

### SUMMARY OF THE INVENTION

In one exemplary embodiment of the invention, a method for implementing vehicle back-up capabilities is provided. The method includes receiving, at a computer processor, dimensions of a vehicle extension for a vehicle make and model. The method also includes integrating, via the computer processor, the dimensions with image software of a recording system on a vehicle having the vehicle make and model. The method further includes translating the dimensions to scale with a scaling component of the recording system, and overlaying a graphical depiction of the vehicle extension with a recorded image on a display device using translated dimensions.

In another exemplary embodiment of the invention a system for implementing vehicle back-up capabilities is provided. The system includes a computer processor and logic executable by the computer processor. The logic implements a method. The method includes receiving dimensions of a vehicle extension for a vehicle make and model. The method also includes integrating the dimensions with image software of a recording system on a vehicle having the vehicle make and model. The method further includes translating the dimensions to scale with a scaling component of the recording system, and overlaying a graphical depiction of the vehicle extension with a recorded image on a display device using translated dimensions.

In yet another exemplary embodiment of the invention, a computer program product for implementing vehicle back-up capabilities is provided. The computer program product comprises a computer-readable storage medium having instructions embodied thereon, which when executed by the computer processor causes the computer processor to implement a method. The method includes receiving dimensions of a vehicle extension for a vehicle make and model. The method also includes integrating the dimensions with image software of a recording system on a vehicle having the vehicle make and model. The method further includes translating the dimensions to scale with a scaling component of the recording system, and overlaying a graphical depiction of the vehicle extension with a recorded image on a display device using translated dimensions.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a system upon which vehicle back-up camera capabilities may be implemented in accordance with an exemplary embodiment;

FIG. 2 is a flow diagram describing a process for implementing vehicle back-up camera capabilities in accordance with an exemplary embodiment;

FIG. 3 is a display device and panel for implementing vehicle back-up camera capabilities in accordance with an exemplary embodiment; and

FIG. 4 is a display device and panel for implementing vehicle back-up camera capabilities in accordance with another exemplary embodiment.

### DESCRIPTION OF THE EMBODIMENTS

The following description is merely exemplary in nature and is not intended to limit the present disclosure, its application or uses.

In accordance with an exemplary embodiment of the invention, vehicle back-up camera capabilities are provided. The exemplary vehicle back-up camera capabilities enable back-up camera systems to visually render a depiction of a vehicle extension, as it would appear if placed in an open or lifted position, onto an image recorded by the back-up system. In doing so, a vehicle operator can better evaluate the distance or movement needed by the vehicle, when in the process of backing up, to get as close to a loading or unloading location as is safely possible. The particular dimensions of the vehicle extension for a given vehicle make and model are supplied to a vehicle processor, which dimensions are processed, and a graphical depiction of the vehicle extension is superimposed over an image recorded by the back up system.

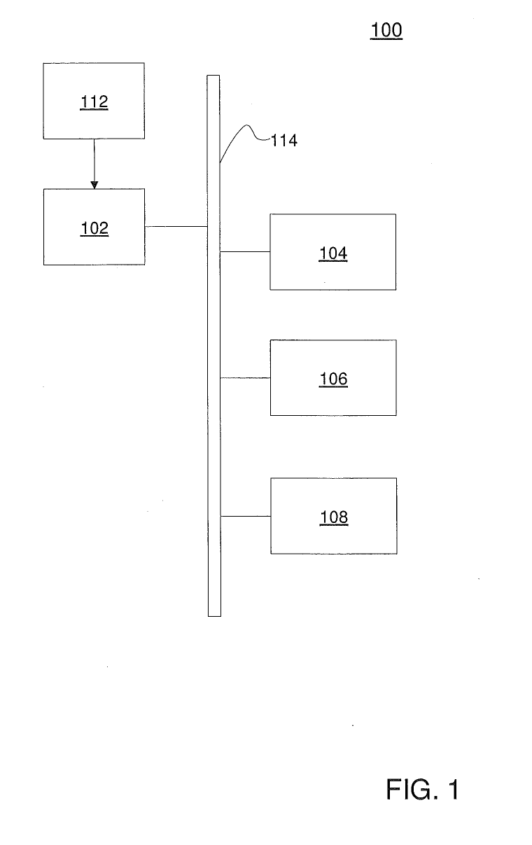

Turning now to FIG. 1, a system 100 upon which the vehicle back-up camera capabilities may be implemented in accordance with an exemplary embodiment will now be described. The system 100 includes components of a vehicle that include a control system 102, a display system 104, a recording device 106, and one or more sensors 108 communicatively coupled to a vehicle bus 114.

The control system 102 includes one or more computer processors that are configured to execute logic 112 for implementing the exemplary vehicle back-up camera capabilities described herein. The control system 102 may be implemented in hardware, software, or a combination thereof. The logic 112 may reside in memory of the control system 102. The logic 112 may be configured with a user interface for enabling the communication of vehicle extension dimensions to the system 100, as will be described herein.

The display system 104 includes a display panel (e.g., liquid crystal display (LCD)) that may be implemented as a panel within a rear-view mirror of the vehicle of system 100, or may be implemented by a display screen built in to a vehicle console (e.g., as part of a navigation or infotainment system). The display system 104 receives recorded images from the recording device 106 for presentation on the display panel. The display system 104 includes a computer processor and logic (not shown) for processing the image data received from the recording device 106. For example, the computer processor of the display system 104 may execute image software that corrects images it receives from the recording system 106. The corrections may include interpolation of digital images to resize the images according to a scaled size of the display panel. The corrections may include altering or enhancing image pixels and reversing the orientation of the images recorded to coincide with a driver's viewpoint. In an embodiment, the computer processor implementing the logic 112 (e.g., control system 102) may be the same computer processor implementing the image software on the display device 104.

The recording device 106 may be implemented as a video camera having a wide angle lens or fish eye lens. The recording device 106 is mounted on a rear end of the vehicle (e.g., near the license plate) and is oriented to record video images of objects located behind the vehicle. Optionally, the vehicle may also include one or more sensors 108 (e.g., motion or impact) that relate distance information of the objects to the vehicle.

The vehicle bus 114 may be a wireline bus (e.g., cabling), a wireless communications bus, or a combination thereof. The vehicle bus 114 may be implemented as a local area network with respect to the vehicle components.

In operation, the control system 102 receives dimensions of a vehicle extension associated with the make and model of the vehicle. For example, the vehicle extension may be a rear tail gate that, once opened, extends the length of the vehicle (i.e., protrude from) an additional 18 inches. A vehicle lift gate may extend the length of the vehicle (i.e., protrude from) an additional 30 inches. The dimensions may also include the width of the vehicle extension. The dimensions may be provided at the time of installation of the vehicle back-up camera system in the vehicle. For example, the dimensions may be entered via the user interface (not shown) of the logic 112. The logic 112 processes recorded images and renders a graphical depiction of the vehicle extension using the dimensions on the display panel.

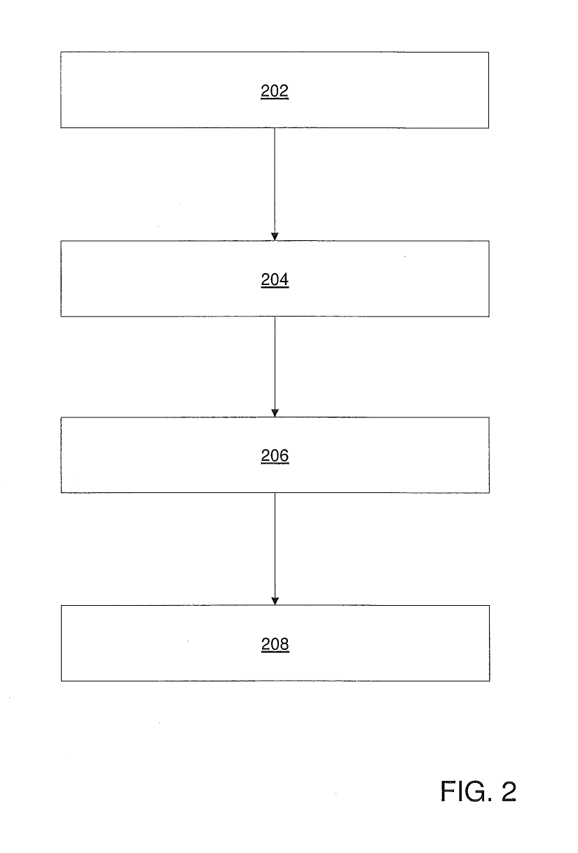

Turning now to FIG. 2, a flow diagram describing a process for implementing vehicle back-up camera capabilities in accordance with an exemplary embodiment will now be described.

At step 202, the dimensions of a vehicle extension are calculated for a particular vehicle make and model. The dimensions are received at the control system 102 via the user interface of the logic 112.

At step 204, the dimensions are integrated with the image software of the display device 104. The dimensions may be integrated to indicate a relative position on the display panel in which the vehicle extension would be seen if physically open or in a lifted position. The dimensions are translated by the image software to produce a scaled version of the dimensions that correspond with the recorded images at step 206. The translated dimensions are converted to a graphical image that is visually similar to the shape of the vehicle extension (e.g., a simulated version of the vehicle extension).

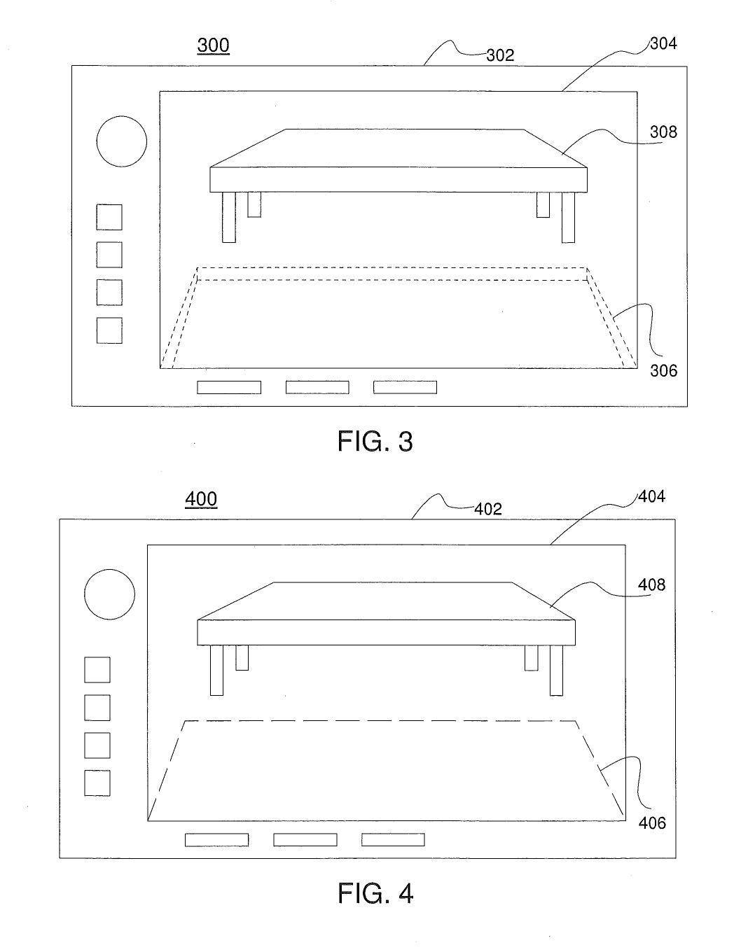

At step 208, the graphical image is overlaid or superimposed on a rendered recorded image on a display panel of the display system 104. As shown in FIG. 3, a display system 300 (corresponding to display system 104) includes a display panel 304. The display panel 304 displays a recorded image 308 and a graphical image 306 of the vehicle extension, which is illustrated in FIG. 3 as a rear tail gate. In FIG. 4, a display system 400 (corresponding to display system 104) includes a display panel 404. The display panel 404 displays a recorded image 408 and a graphical image 406 of the vehicle extension, which is illustrated in FIG. 4 as a rear lift gate. The graphical image may be translucently superimposed over the recorded image. In one embodiment, the graphical image may be rendered to visually simulate the vehicle extension, as shown in FIG. 3. In another embodiment, the graphical image may be rendered as an outline of the vehicle extension, as shown in FIG. 4.

In one embodiment, the logic 112 may be configured to enable a user to select which visual rendition of the vehicle extension to present on the display (e.g., the visual simulation, the outline, or other method of rendering. The selection by the user may be implemented, e.g., using control options on the display device 104 if so configured.

It will be understood that while only one recording device 106 is described herein, multiple recording devices (e.g., video cameras) may be utilized in order to realize the exemplary embodiments of the invention. In addition, the sensors 108 may be used in conjunction with the vehicle extension rendering to warn or notify an operator of an approaching obstacle.

Technical effects include vehicle back-up camera capabilities. The vehicle back-up camera capabilities enable back-up camera systems to visually render a depiction of a vehicle extension, as it would appear if placed in an open or lifted position, onto an image recorded by the back-up system. In doing so, a vehicle operator can better evaluate the distance or movement needed by the vehicle, when in the process of backing up, to get as close to a loading or unloading location as is safely possible. The particular dimensions of the vehicle extension for a given vehicle make and model are supplied to a vehicle processor, which dimensions are processed, and a graphical depiction of the vehicle extension is superimposed over an image recorded by the back up system.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the application.

What is claimed is:

1. A method, comprising:
receiving, at a computer processor, dimensions of a vehicle extension for a vehicle make and model;
integrating, via the computer processor, the dimensions with image software of a recording system on a vehicle having the vehicle make and model;
translating the dimensions to scale with a scaling component of the recording system; and
overlaying a graphical depiction of the vehicle extension with a recorded image on a display device using translated dimensions.

2. The method of claim 1, wherein the vehicle extension is a tail gate disposed on a rear end of the vehicle.

3. The method of claim 1, wherein the vehicle extension is a lift gate disposed on a rear end of the vehicle.

4. The method of claim 1, wherein the graphical depiction is translucently superimposed with the recorded image.

5. The method of claim 1, wherein the graphical depiction is an outline of the vehicle extension superimposed with the recorded image.

6. The method of claim 1, wherein the vehicle extension is a tail gate and the graphical depiction of the tail gate is superimposed at a location on the recorded image corresponding to a real life location of the tail gate when put in an open position.

7. The method of claim 1, wherein the vehicle extension is a lift gate and the graphical depiction of the lift gate is superimposed at a location on the recorded image corresponding to a real life location of the lift gate when put in a lifted position.

8. A system, comprising:
a computer processor integrated within a vehicle; and
logic executable by the computer processor, the logic implementing a method, comprising:
receiving dimensions of a vehicle extension for a vehicle make and model;
integrating the dimensions with image software of a recording system on a vehicle having the vehicle make and model;
translating the dimensions to scale with a scaling component of the recording system; and
overlaying a graphical depiction of the vehicle extension with a recorded image on a display device using translated dimensions.

9. The system of claim 8, wherein the vehicle extension is a tail gate disposed on a rear end of the vehicle.

10. The system of claim 8, wherein the vehicle extension is a lift gate disposed on a rear end of the vehicle.

11. The system of claim 8, wherein the graphical depiction is translucently superimposed with the recorded image.

12. The system of claim 8, wherein the graphical depiction is an outline of the vehicle extension superimposed with the recorded image.

13. The system of claim 8, wherein the vehicle extension is a tail gate and the graphical depiction of the tail gate is superimposed at a location on the recorded image corresponding to a real life location of the tail gate when put in an open position.

14. The system of claim 8, wherein the vehicle extension is a lift gate and the graphical depiction of the lift gate is superimposed at a location on the recorded image corresponding to a real life location of the lift gate when put in a lifted position.

15. A computer program product comprising a computer-readable storage medium having instructions embodied thereon, which when executed by a computer cause a computer to implement a method, the method comprising:
receiving dimensions of a vehicle extension for a vehicle make and model;
integrating the dimensions with image software of a recording system on a vehicle having the vehicle make and model;
translating the dimensions to scale with a scaling component of the recording system; and
overlaying a graphical depiction of the vehicle extension with a recorded image on a display device using translated dimensions.

16. The computer program product of claim 15, wherein the vehicle extension is a tail gate disposed on a rear end of the vehicle.

17. The computer program product of claim 15, wherein the vehicle extension is a lift gate disposed on a rear end of the vehicle.

18. The computer program product of claim 15, wherein the graphical depiction is translucently superimposed with the recorded image.

19. The computer program product of claim 15, wherein the graphical depiction is an outline of the vehicle extension superimposed with the recorded image.

20. The computer program product of claim 15, wherein the vehicle extension is a tail gate and the graphical depiction of the tail gate is superimposed at a location on the recorded image corresponding to a real life location of the tail gate when put in an open position.
